(19) United States
(12) Patent Application Publication
(10) Pub. No.: US 2009/0148253 A1
(43) Pub. Date: Jun. 11, 2009

(54) CONNECTOR LOCK

(75) Inventor: Albertus Abraham Petrus de Groot, Uithoorn (NL)

Correspondence Address: WESTMAN CHAMPLIN & KELLY, P.A., SUITE 1400, 900 SECOND AVENUE SOUTH, MINNEAPOLIS, MN, 55402, US

(73) Assignee: Interparts Automotive B.V., Uithoorn (NL)

(21) Appl. No.: 12/328,015

(22) Filed: Dec. 4, 2008

(30) Foreign Application Priority Data
Dec. 5, 2007 (GB) 0723769.6

(51) Int. Cl. F16B 39/32; F16B 39/00; F16B 39/02

(52) U.S. Cl. 411/204

(57) ABSTRACT

A locking device with a ratchet to secure two or more screw-action connectors for axial rotation in one direction and to allow rotation of the connectors in an opposite axial direction. The locking device having two rings with teeth on the outer side, each ring to fit around one of the connectors, and assembled with a body with teeth on the inner side, enclosing the two rings, where the mating teeth of ring and body generate the ratchet, to allow ratcheting the ring in one axial direction, and blocking the axial rotation of the ring and connector in the opposite direction.

### PRIORITY CLAIM

This application claims the priority benefits under 35 U.S.C. § 119 of Great Britain Patent Application 0723769.6, filed Dec. 5, 2007, which is also incorporated herein by reference in its entirety.

### BACKGROUND

The discussion below is merely provided for general background information and is not intended to be used as an aid in determining the scope of the claimed subject matter.

Aspects of the invention relate to inhibiting connectors such as fasteners from loosening.

A common method for attaching a vehicle wheel to a rotating hub, is to provide a number of fixed threaded studs on the rotatable hub. The wheel is attached to the hub by means of wheel nuts engaging the studs passing through opening spaces in the wheel. It is common to use right and left threaded studs.

Because of common experience that nuts, or fasteners, get loose in service on trucks, trailers and buses, this can lead to a loose wheel on the vehicle in use.

Specifically in the bus industry it is common to have procedures to re-torque the wheel nut fasteners after initial fit, and to re-torque these fasteners within the next day and/or days and during the regular maintenance service.

Locking devices like the ones mentioned in the patents GB2229241 and EP1169183, do have a locking function in both directions, but aren't capable of adjusting or rotating the nut in one direction.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

A device for making a connection between two or more connectors, like wheel nuts, is described. The device contains a ratchet, while fitted on the fasteners, that allows axial rotation of the fastener in one direction, and the device blocks the fastener from rotating in the opposite axial direction.

The function of the device is to inhibit the fastener from becoming loose, and while fitted on the fastener, adjustment of the fastener, during the fastening process or checking processes.

The device has a limited height, so the device can stay on the fastener during torque and re-torque of the fasteners. In most truck, trailer and bus applications a device up to around a height of 9 mm, can stay on the fastener during the proper use of tools, like a socket wrench.

One of the embodiments is a device that can be used for right and left threaded fasteners, just by fitting the device on the other side.

### BRIEF DESCRIPTION OF THE DRAWING

Hereinafter aspects of the invention are illustrated in the figures, in which:

FIG. 1 shows a detail of the body and teeth of a portion of a locking device;

FIG. 2 shows the ring which comprises an inner mating structure to a hexagon nut and an outer side of the ring showing teeth;

FIG. 3 shows a portion of the locking device with ring and body;

FIG. 4 shows an assembled part of the locking device and in detail the ratchet between the teeth of the ring and the teeth of the body;

FIG. 5 shows a complete locking device containing two assembled bodies and rings, fitted on two fasteners;

FIG. 6 shows a top-view of a body with a device, where the teeth of the body are positioned on a strip connected to the body, and a detail of the body, specifically showing the strip and the teeth;

FIG. 7 shows a side-view of a body, indicating the height in mm;

FIG. 8 shows an assembled locking device, with ring and body including the teeth of the body, disposed on a strip,

FIG. 9 shows an enlarged portion of FIG. 8,

FIG. 10 shows a portion of an embodiment where teeth of the ring are disposed on a strip,

FIG. 11 shows schematically a body in the shape of a ring, and

FIG. 12 shows schematically a body in the shape of a partial ring.

### DETAILED DESCRIPTION

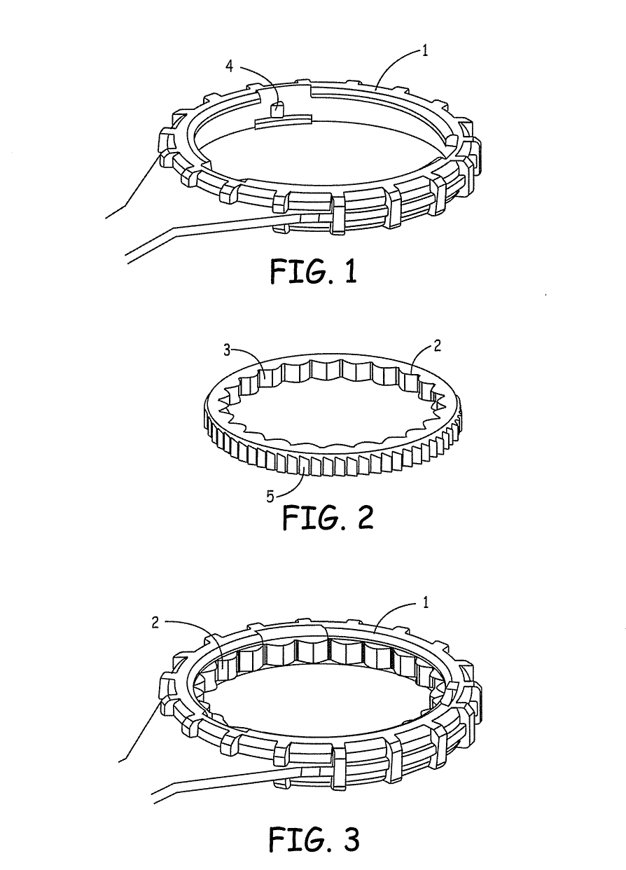

FIGS. 1-5 show a locking device (6) having a body (1) with spaced apart apertures, wherein an inner ring (2) is disposed in each aperture. The inner ring (2) is fitted over a rotatable connector (7) (herein by way of example, a screw-action fastener) and mates with the fastener (7) in such a way that if the fastener (7) axially rotates, the ring (2) rotates with it.

In one of the embodiments, the inner side of the ring (2) is a hexagon design, or a multiple fit, and mates the hexagon nut (7).

In practice the device (6) will be fitted over two or more fasteners (7), and in case the position of the ring (2) doesn't match exactly the position of the fastener (7), like a hexagon design, it is preferable that the body (1) is slightly flexible, to accommodate the fitting.

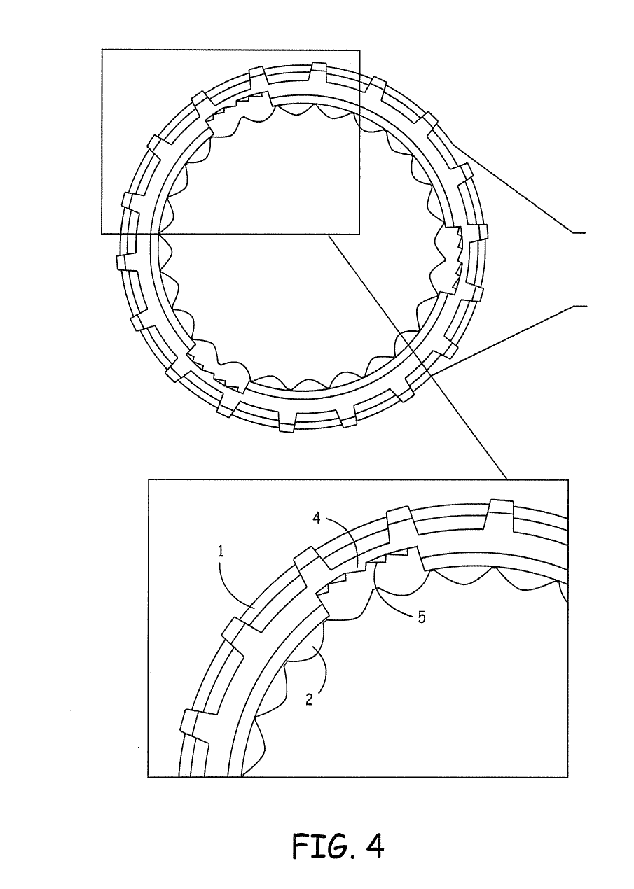

The device (6) contains a body (1) which, when fitted over two or more rings (2) and fasteners, provides the rigid reference for a ratchet. The body (1) contains teeth (4) mating the teeth (5) of the ring (2), so the combination makes a ratchet shown in FIG. 4, and allows the ring (2) to rotate in one direction.

In case the ring (2) is forced by the fastener (7) to rotate in the opposite axial direction as a result of loosening, the teeth (4 and 5) of the ring (2) and the body (1) hook into each other, and prevent an axial rotation (see FIG. 4). So in case the fastener (7) starts to become loose, it is blocked for axial rotation.

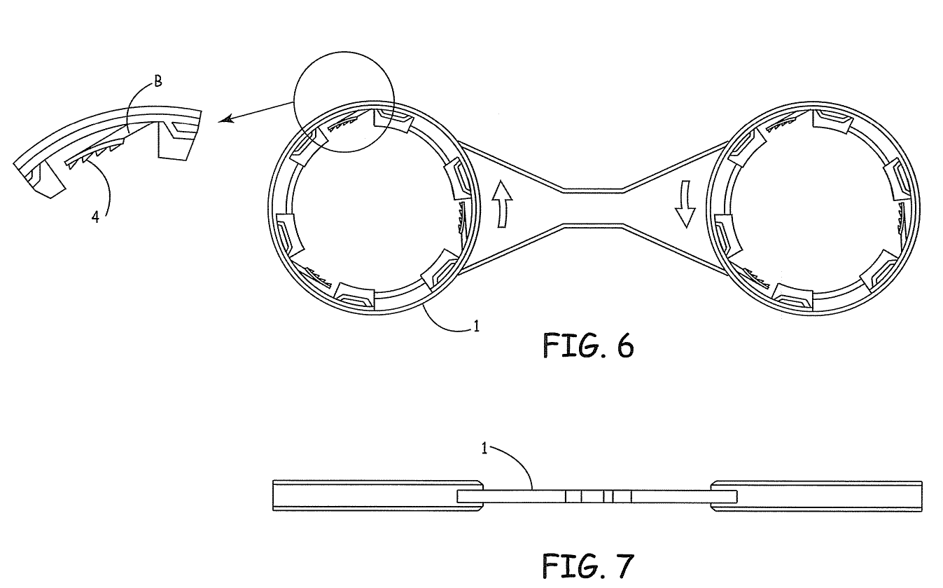

Another version is to provide the teeth (4) as shown in FIGS. 6 and 7 on a strip (8). Using the elasticity of the material of the strip (8), the teeth (4) will bounce or displace during the adjustable phase of axial rotation of the ring (2) during ratcheting, and functioning as snap fingers, to minimize wear or damage on the teeth of these both parts.

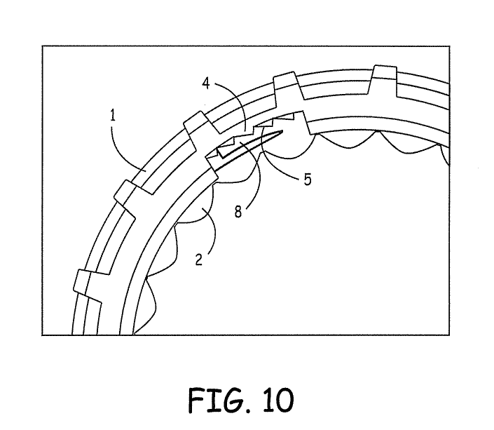

An alternative version illustrated in FIG. 10 is to put the teeth (5) of the ring (2) on a strip (8), with the same function.

One of the versions is to use flexible materials so the play between both teeth can be very limited or not existing, and the elasticity of one or both materials, allowing the teeth ratcheting over each other, with no or limited wear.

Materials such as but not limited to PE, PP and PA, and polymers or hybrids of these are very suitable for this invention.

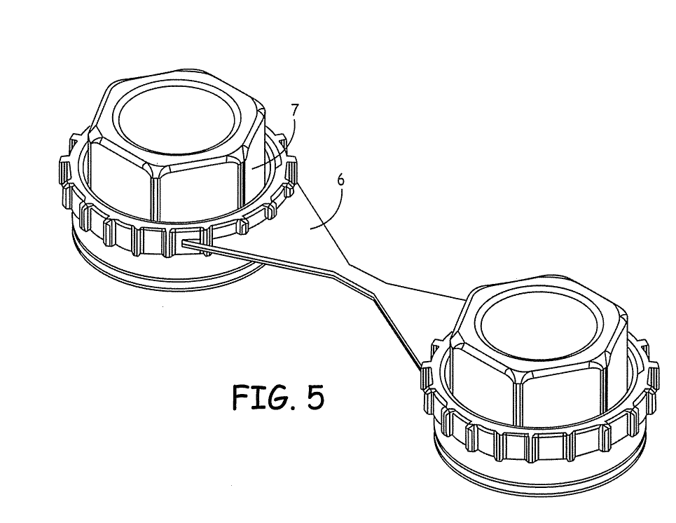

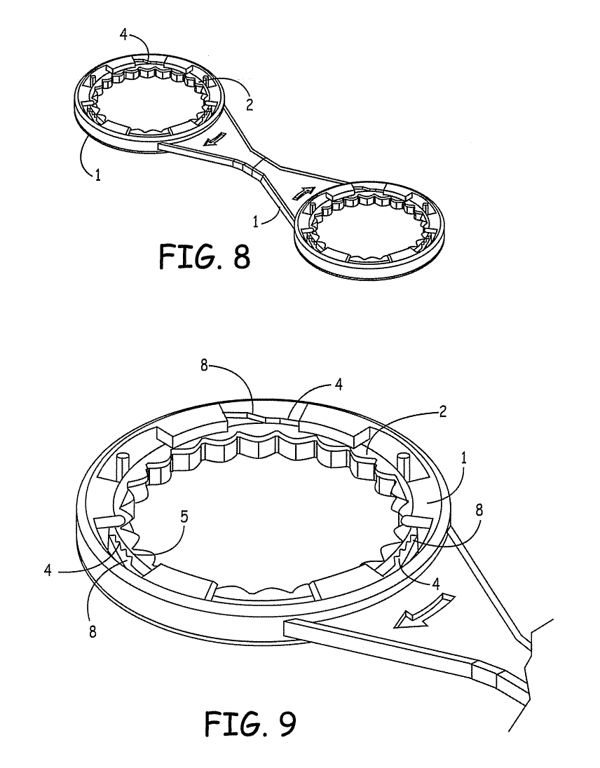

A different embodiment is to make the device (6), containing two or more bodies (1), out of two, as illustrated in FIG. 8, or more parts, which can be assembled to form one body. The device (6) is particularly useful with use with wheel nuts on a wheel. In FIG. 5, the fasteners (7) are shown as wheel nuts, where the wheel nuts herein also represent a wheel of a vehicle.

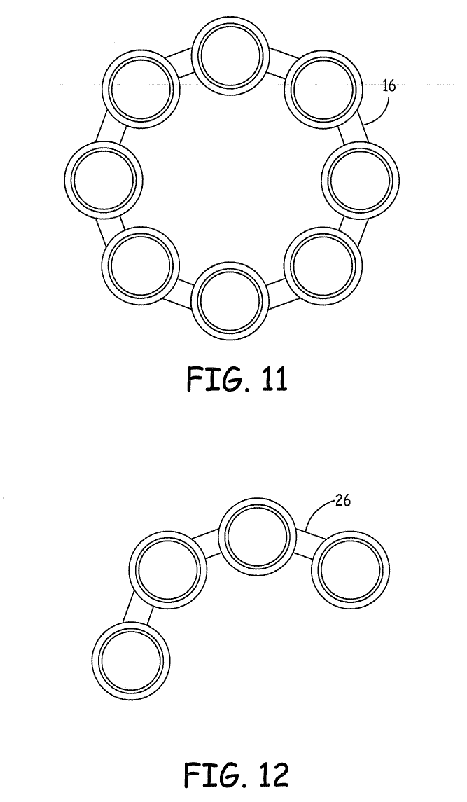

Also the device (6) can link more than two fasteners (7) wherein the shape of body and configuration of the apertures for the inner rings can take numerous forms. For instance, in another embodiment illustrated in FIG. 11, a body (16) includes a plurality of inner rings and corresponding ratcheting mechanisms and is in the shape of a ring for covering and linking a plurality of fasteners (7), for example all fasteners on a wheel of a vehicle. In yet another embodiment illustrated in FIG. 12, a body (26) can be in the shape of a partial ring having a plurality of inner rings and corresponding ratcheting mechanisms.

In case the fasteners are threaded right-handed, and therefore a clockwise rotation of the fastener provides a fastening, the device should be fitted with the ratchet in clockwise direction. For fasteners threaded left-handed, the device can be used by configuring it in a way so the ratchet is working counter-clockwise.

In a further embodiment, the device has a height or thickness that allows the device to stay on the fasteners during torque and re-torque of the fasteners. For example, in most truck, trailer and bus applications a device up to around a height of 9 mm, can stay on the fastener during the proper use of tools, like a socket wrench.

Although the subject matter has been described in language specific to structural features and/or methodological acts, it is to be understood that the subject matter defined in the appended claims is not necessarily limited to the specific features or acts described above as has been determined by the courts. Rather, the specific features and acts described above are disclosed as example forms of implementing the claims.

What is claimed is:

1. A locking device for rotatable connectors, the locking device comprising:
a body having two apertures, each aperture having teeth;
two rings, each ring having teeth on an outer side thereof and configured to fit around a connector, wherein a ring is disposed in each aperture and wherein the mating teeth of each ring and body form a ratchet to allow ratcheting the ring in one axial direction, and blocking the axial rotation of the ring and connector in the opposite direction.

2. The locking device according to claim 1, where the teeth of the body are fabricated on a strip.

3. The locking device according to claim 1, wherein the teeth of the ring are fabricated on a strip.

4. The locking device according to claim 1, wherein a thickness of the device allows the device to stay on the fasteners during torque and re-torque of the connectors.

5. The locking device according to claim 1, wherein the body links more than two connectors.

6. The locking device according to claim 1, wherein the body contains more than one piece.

7. The locking device according to claim 1, fabricated out of polymers or hybrids

8. The locking device according to claim 1 wherein the connectors are wheel nuts for a vehicle.

9. The locking device according to claim 8, wherein the body is fabricated in at least a partial ring for engaging more than two wheel nuts.

10. In combination with wheel nuts of a vehicle, a locking device for engaging the wheel nuts, the locking device comprising:
a body having a plurality of apertures, each aperture having teeth;
a plurality of rings, each ring having teeth on an outer side thereof and configured to fit around a wheel nut, wherein a ring is disposed in each aperture and wherein the mating teeth of each ring and body form a ratchet to allow ratcheting the ring in one axial direction, and blocking the axial rotation of the ring and wheel nut in the opposite direction.

11. The combination according to claim 10 wherein the body comprises two apertures and the plurality of rings comprises two rings.

12. The combination according to claim 10 wherein the body comprises more than two apertures and the plurality of rings comprises more than two rings.

13. The combination according to claim 12, wherein the body is fabricated in at least a partial ring for engaging more than two wheel nuts.

14. The combination according to claim 12, wherein the body is fabricated in a ring for engaging all the wheel nuts of a wheel.
